(19) United States
(12) Patent Application Publication
(10) Pub. No.: US 2025/0167499 A1
(43) Pub. Date: May 22, 2025

(54) CONNECTOR ASSEMBLY

(71) Applicant: Japan Aviation Electronics Industry, Limited, Tokyo (JP)

(72) Inventor: Osamu HASHIGUCHI, Tokyo (JP)

(21) Appl. No.: 18/894,134

(22) Filed: Sep. 24, 2024

(30) Foreign Application Priority Data
Nov. 16, 2023 (JP) 2023-195050

(51) Int. Cl. H01R 24/84; H01R 13/52; H01R 13/627

(52) U.S. Cl. CPC H01R 24/84; H01R 13/5219; H01R 13/6271

(57) ABSTRACT

A connector assembly includes a first connector and a second connector having an identical configuration, the first connector including a first waterproof sheet disposed on a first joining surface of planar shape in a first insulator so as to surround a first contact accommodating portion in which a first contact is accommodated, the second connector including a second waterproof sheet disposed on a second joining surface of planar shape in a second insulator so as to surround a second contact accommodating portion in which a second contact is accommodated, when the first connector and the second connector are fitted with each other, the first waterproof sheet and the second waterproof sheet are closely adhered to each other, and the first contact and the second contact make contact with each other, whereby the first electric wire and the second electric wire are electrically connected to each other.

### BACKGROUND OF THE INVENTION

The present invention relates to a connector assembly, particularly to a connector assembly in which a first connector and a second connector are fitted with each other, the first connector being joined to an end portion of a first electric wire, and the second connector being joined to an end portion of a second electric wire and having the same configuration as that of the first connector.

Conventionally, there has been known a connector for connecting two electric wires to each other.

For instance, JPH 8-55657 A discloses a connector assembly that connects a plurality of electric wires to one another by fitting a first connector 1 and a second connector 2 with each other, as shown in FIG. 43. The first connector 1 and the second connector 2 have the same configuration and are each hermaphroditically formed.

The first connector 1 includes a first insulator 3 and a plurality of first contacts 4 retained in the first insulator 3. The first insulator 3 includes a blade portion 3A of flat plate shape which extends forward in the first connector 1 and on which the plurality of first contacts 4 are disposed, and a pair of guide portions 3B that are adjacent to opposite lateral portions of the blade portion 3A and extend forward in a different plane from the blade portion 3A.

As with the first connector 1, the second connector 2 includes a second insulator 5 and a plurality of second contacts 6 (not shown) retained in the second insulator 5. The second insulator 5 includes a blade portion 5A of flat plate shape which extends forward in the second connector 2 and on which the plurality of second contacts 6 are disposed, and a pair of guide portions 5B that are adjacent to opposite lateral portions of the blade portion 5A and extend forward in a different surface from the blade portion 5A.

As shown in FIG. 43, when the first connector 1 and the second connector 2 are inserted into each other while facing in longitudinally, horizontally, and vertically opposite directions, the blade portion 3A and the blade portion 5A are superposed on each other, and the pair of guide portions 3B and the pair of guide portions 5B are superposed on each other to make contact with each other, whereby the fitted state is established between the first connector 1 and the second connector 2.

Thus, as shown in FIG. 44, a contacting portion 4A of each of the first contacts 4 disposed at the blade portion 3A and a contacting portion 6A of each of the second contacts 6 disposed at the blade portion 5A elastically contact each other, and the plurality of first contacts 4 and the plurality of second contacts 6 are electrically connected with each other.

When the contacting portion 4A of each of the plurality of first contacts 4 and the contacting portion 6A of each of the plurality of second contacts 6 elastically contact each other, the first connector 1 and the second connector 2 receive forces exerted in directions away from each other; however, the pair of guide portions 3B and the pair of guide portions 5B shown in FIG. 43 face each other and make contact with each other, whereby the fitted state between the first connector 1 and the second connector 2 is maintained.

A connector assembly of this type is desired to have a waterproof structure in order to prevent water from entering a contact part between the first contact 4 and the second contact 6 from the outside. However, each of the first insulator 3 and the second insulator 5 includes the blade portion 3A, 5A extending forward and the pair of guide portions 3B, 5B extending forward in a plane different from a plane in which the blade portion 3A, 5A extends, and the blade portion 3A and the blade portion 5A are superposed on each other, while the pair of guide portions 3B and the pair of guide portions 5B are superposed on each other, whereby the fitted state is established.

Since the first insulator 3 and the second insulator 5 each have such a complicated structure, it is difficult to form a waterproof structure.

### SUMMARY OF THE INVENTION

The present invention has been made in order to solve the conventional problem described above and is aimed at providing a connector assembly capable of establishing waterproofing function with a simple structure while electric wires are connected to each other by means of a first connector and a second connector that have the same configuration.

A connector assembly according to the present invention is one in which a first connector and a second connector are fitted with each other, the first connector being joined to an end portion of a first electric wire, and the second connector being joined to an end portion of a second electric wire and having a same configuration as that of the first connector,
wherein the first connector includes: a first insulator; a first contact retained by the first insulator and connected to the end portion of the first electric wire; and a first waterproof sheet,
the second connector includes: a second insulator; a second contact retained by the second insulator and connected to the end portion of the second electric wire; and a second waterproof sheet,
the first insulator includes: a first joining surface of planar shape; and a first contact accommodating portion of recess shape which is formed in the first joining surface and in which the first contact is accommodated,
the second insulator includes: a second joining surface of planar shape facing the first joining surface; and a second contact accommodating portion of recess shape which is formed in the second joining surface and in which the second contact is accommodated, and
the first waterproof sheet is disposed on the first joining surface so as to surround the first contact accommodating portion,
the second waterproof sheet is disposed on the second joining surface so as to surround the second contact accommodating portion, and
when the first connector and the second connector are fitted with each other, the first waterproof sheet and the second waterproof sheet are sandwiched between the first joining surface and the second joining surface and closely adhered to each other, and the first contact and the second contact make contact with each other, whereby the first electric wire and the second electric wire are electrically connected to each other.

### BRIEF DESCRIPTION OF THE DRAWINGS

FIG. 1 is a perspective view showing a connector assembly of Embodiment 1 in a fitted state.

FIG. 2 is a plan view showing the connector assembly of Embodiment 1 in the fitted state.

FIG. 3 is a side view showing the connector assembly of Embodiment 1 in the fitted state.

FIG. 4 is a perspective view showing the connector assembly of Embodiment 1 in a non-fitted state.

FIG. 5 is an assembly view of a first connector in the connector assembly of Embodiment 1.

FIG. 6 is a perspective view showing a first insulator of the first connector in Embodiment 1.

FIG. 7 is a perspective view showing a first contact of the first connector in Embodiment 1.

FIG. 8 is a plan view showing the first connector in Embodiment 1.

FIG. 9 is a cross-sectional view taken along line B-B in FIG. 8.

FIG. 10 is a cross-sectional view showing a second connector in Embodiment 1 and corresponding to FIG. 9.

FIG. 11 is a cross-sectional view taken along line A-A in FIG. 2.

FIG. 12 is an enlarged partial view showing a first locking portion and a second locked portion of the connector assembly of Embodiment 1 in the fitted state.

FIG. 13 is a perspective view showing a connector assembly of Embodiment 2 in the fitted state.

FIG. 14 is a plan view showing the connector assembly of Embodiment 2 in the fitted state.

FIG. 15 is a side view showing the connector assembly of Embodiment 2 in the fitted state.

FIG. 16 is a perspective view showing the connector assembly of Embodiment 2 in a non-fitted state.

FIG. 17 is an assembly view of a first connector in the connector assembly of Embodiment 2.

FIG. 18 is a perspective view showing a first insulator of the first connector in Embodiment 2.

FIG. 19 is a perspective view showing a first contact of the first connector in Embodiment 2.

FIG. 20 is a plan view showing the first connector in Embodiment 2.

FIG. 21 is a cross-sectional view taken along line D-D in FIG. 20.

FIG. 22 is a cross-sectional view showing a second connector in Embodiment 2 and corresponding to FIG. 21.

FIG. 23 is a perspective view showing the connector assembly of Embodiment 2 before the first connector and the second connector are linearly slid.

FIG. 24 is a side view showing the connector assembly of Embodiment 2 before the first connector and the second connector are linearly slid.

FIG. 25 is a cross-sectional side view showing the connector assembly of Embodiment 2 before the first connector and the second connector are linearly slid.

FIG. 26 is a cross-sectional view taken along line C-C in FIG. 14.

FIG. 27 is an enlarged partial view showing a first locking portion and a second locked portion of the connector assembly of Embodiment 2 in the fitted state.

FIG. 28 is a perspective view showing a connector assembly of Embodiment 3 in the fitted state.

FIG. 29 is a plan view showing the connector assembly of Embodiment 3 in the fitted state.

FIG. 30 is a side view showing the connector assembly of Embodiment 3 in the fitted state.

FIG. 31 is a perspective view showing the connector assembly of Embodiment 3 in a non-fitted state.

FIG. 32 is an assembly view of a first connector in the connector assembly of Embodiment 3.

FIG. 33 is a perspective view showing a first insulator of the first connector in Embodiment 3.

FIG. 34 is a perspective view showing a first contact of the first connector in Embodiment 3.

FIG. 35 is a plan view showing the first connector in Embodiment 3.

FIG. 36 is a cross-sectional view taken along line F-F in FIG. 35.

FIG. 37 is a cross-sectional view showing a second connector in Embodiment 3 and corresponding to FIG. 36.

FIG. 38 is a perspective view showing the connector assembly of Embodiment 3 before the first connector and the second connector are rotated and slid.

FIG. 39 is a side view showing the connector assembly of Embodiment 3 before the first connector and the second connector are rotated and slid.

FIG. 40 is a cross-sectional side view showing the connector assembly of Embodiment 3 before the first connector and the second connector are rotated and slid.

FIG. 41 is a cross-sectional view taken along line E-E in FIG. 29.

FIG. 42 is an enlarged partial view showing a first locking portion and a second locked portion of the connector assembly of Embodiment 3 in the fitted state.

FIG. 43 is a perspective view showing a conventional connector assembly in a non-fitted state.

FIG. 44 is a cross-sectional view showing the conventional connector assembly in a fitted state.

### DETAILED DESCRIPTION OF THE INVENTION

Embodiments of the present invention are described below based on the accompanying drawings.

### Embodiment 1

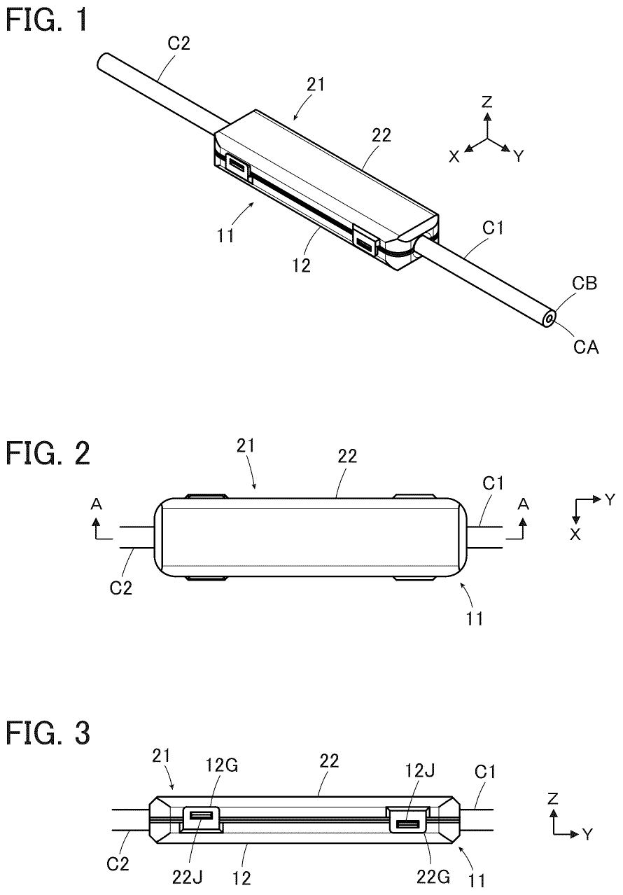

FIGS. 1 to 3 show a connector assembly according to Embodiment 1. The connector assembly includes a first connector 11 and a second connector 21, and when the second connector 21 is pressed relatively against the first connector 11, the first connector 11 and the second connector 21 are fitted with each other, and a first electric wire C1 and a second electric wire C2 are electrically connected to each other.

The first connector 11 is joined to an end portion of the first electric wire C1, while the second connector 21 is joined to an end portion of the second electric wire C2. The first electric wire C1 and the second electric wire C2 are each formed of a coated electric wire in which an outer periphery of a conductor portion CA is covered with an insulating coating portion CB, and extend in opposite directions from each other on the same straight line.

The first connector 11 includes a first insulator 12 extending in a direction in which the first electric wire C1 extends, while the second connector 21 includes a second insulator 22 extending in a direction in which the second electric wire C2 extends. The first connector 11 and the second connector 21 are fitted with each other with the second insulator 22 being superposed on the first insulator 12.

For convenience, a direction from the first connector 11 toward the second connector 21 in a fitted state between the first connector 11 and the second connector 21 is referred to as “+Z direction,” a direction in which the first electric wire C1 and the second electric wire C2 extend “Y direction,” and a width direction of each of the first insulator 12 and the second insulator 22, that is, a direction orthogonal to a YZ plane “X direction.”

The first connector 11 and the second connector 21 have the same configuration, and the first connector 11 is joined to a −Y directional end portion of the first electric wire C1, while the second connector 21 is joined to a +Y directional end portion of the second electric wire C2.

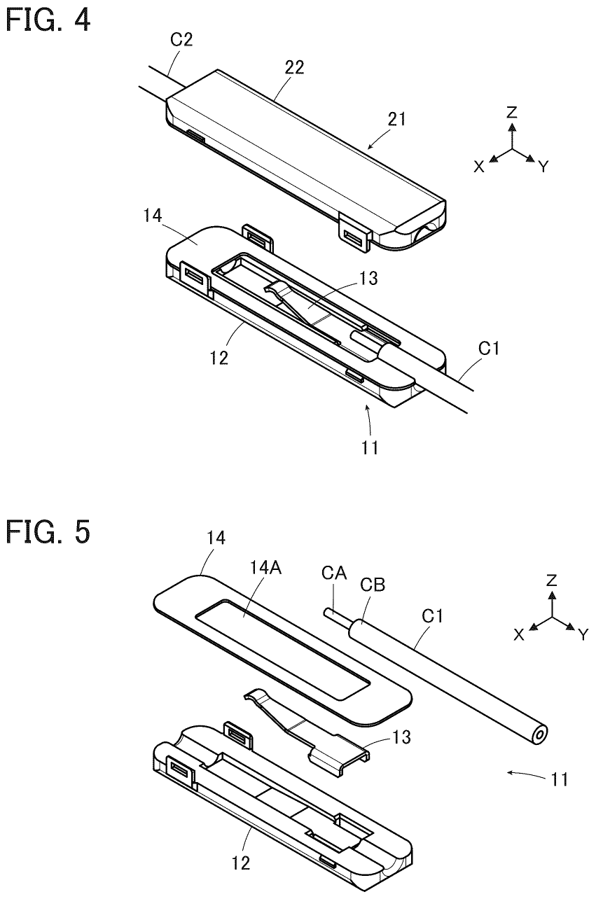

FIG. 4 shows the connector assembly of Embodiment 1 in a non-fitted state. The first connector 11 and the second connector 21 have the same configuration and are each hermaphroditically formed. The second connector 21 is fitted with the first connector 11 while oppositely facing in the X direction, the Y direction, and the Z direction from the first connector 11.

FIG. 5 shows an assembly view of the first connector 11. A first contact 13 is disposed on the +Z direction side of the first insulator 12, a first waterproof sheet 14 is disposed on the +Z direction side of the first contact 13, and the first electric wire C1 is disposed on the +Z direction side of the first waterproof sheet 14.

The first waterproof sheet 14 has a shape corresponding to an outer shape of the first insulator 12 when viewed from the +Z direction and is provided at the center thereof with a rectangular opening portion 14A extending in the Y direction. In addition, at the −Y directional end portion of the first electric wire C1, the insulating coating portion CB is removed to expose the conductor portion CA, and the exposed conductor portion CA of the first electric wire C1 is situated on the +Z direction side of the first contact 13 via the opening portion 14A of the first waterproof sheet 14.

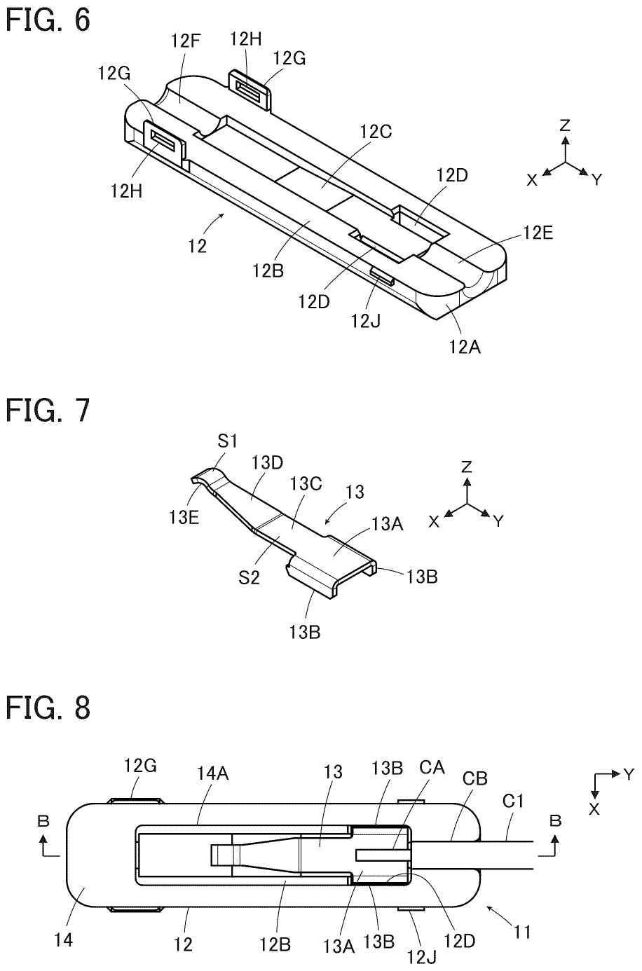

As shown in FIG. 6, the first insulator 12 is made of an insulating resin and includes a flat plate portion 12A of substantially rectangular shape extending in the Y direction along an XY plane. The flat plate portion 12A has a first joining surface 12B of planar shape facing in the +Z direction, and a first contact accommodating portion 12C of recess shape formed in the first joining surface 12B and opening in the +Z direction. The first contact accommodating portion 12C extends in the Y direction, and a pair of press-fitting holes 12D are respectively formed on the +X direction side and the −X direction side of a +Y directional end portion of the first contact accommodating portion 12C.

In addition, the first joining surface 12B is provided with: a first electric wire accommodating groove 12E extending in the Y direction from the first contact accommodating portion 12C to a +Y directional end portion of the first insulator 12; and a second electric wire accommodating groove 12F extending in the Y direction from the first contact accommodating portion 12C to a −Y directional end portion of the first insulator 12.

That is, in an XY plane, the periphery of the first contact accommodating portion 12C is completely surrounded by the first joining surface 12B of planar shape, the first electric wire accommodating groove 12E, and the second electric wire accommodating groove 12F.

Further, at opposite lateral portions of the flat plate portion 12A on the +X direction side and the −X direction side of the second electric wire accommodating groove 12F, a pair of flat plate-shaped first locking portions 12G are separately formed to overhang outward in the X direction from the flat plate portion 12A and protrude in the +Z direction. The first locking portion 12G is provided with a through-hole 12H penetrating the same in the X direction.

In addition, at opposite lateral portions of the flat plate portion 12A on the +X direction side and the −X direction side of the first electric wire accommodating groove 12E, a pair of first locked portions 12J are separately formed to overhang outward in the X direction from the flat plate portion 12A.

As shown in FIG. 7, the first contact 13 is formed of a metal sheet having conductivity and being bent and includes an electric wire connection portion 13A of substantially rectangular shape extending along an XY plane, and a pair of leg portions 13B being bent in the −Z direction separately from a +X directional end portion and a −X directional end portion of the electric wire connection portion 13A.

Further, the first contact 13 includes an extending portion 13C extending in the −Y direction from the electric wire connection portion 13A so as to form the same plane as that of the electric wire connection portion 13A, and an arm portion 13D extending further in the −Y direction from the extending portion 13C, and at a −Y directional end portion of the arm portion 13D, a first protrusion portion 13E is formed to be curved so as to protrude in the +Z direction. A +Z directional surface of the first protrusion portion 13E forms a tip end-side contacting portion S1, while a +Z directional surface of the extending portion 13C forms a base end-side contacting portion S2.

As shown in FIG. 8, in the first connector 11, the pair of leg portions 13B of the first contact 13 are press-fitted into the pair of press-fitting holes 12D of the first insulator 12, whereby the first contact 13 is accommodated in and retained by the first contact accommodating portion 12C. In addition, the first waterproof sheet 14 made of a rubber material or the like is disposed on the first joining surface 12B of the first insulator 12, and the first contact 13 is exposed through the opening portion 14A of the first waterproof sheet 14.

Part of the conductor portion CA exposed from the insulating coating portion CB near the −Y directional end portion of the first electric wire C1 is connected to the electric wire connection portion 13A of the first contact 13 by, for example, soldering.

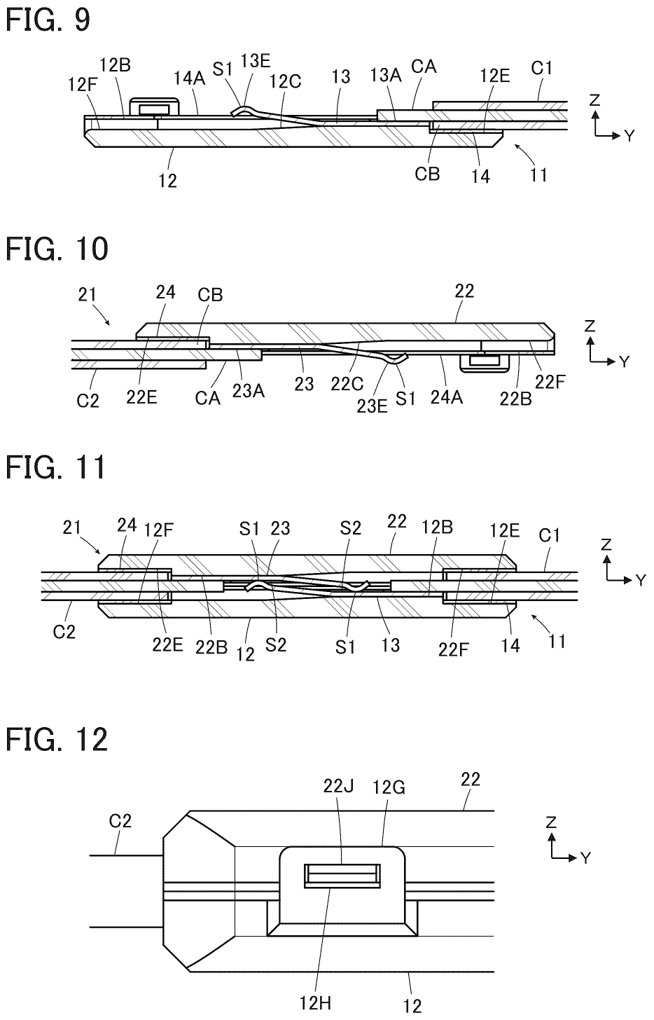

As shown in FIG. 9, a −Z directional part of the insulating coating portion CB near the −Y directional end portion of the first electric wire C1 is accommodated in the first electric wire accommodating groove 12E of the first insulator 12 via the first waterproof sheet 14.

Note that the first protrusion portion 13E of the first contact 13 is situated on the +Z direction side of the first joining surface 12B of the first insulator 12 via the opening portion 14A of the first waterproof sheet 14, and the tip end-side contacting portion S1 faces in the +Z direction.

Here, FIG. 10 shows the second connector 21 to be fitted with the first connector 11. The second connector 21 has the same configuration as that of the first connector 11 and is fitted with the first connector 11 while oppositely facing in the X direction, the Y direction, and the Z direction from the first connector 11.

As shown in FIG. 10, in the second connector 21, a second contact 23 is accommodated in and retained by a second contact accommodating portion 22C of the second insulator 22, a second waterproof sheet 24 made of a rubber material or the like is disposed on a second joining surface 22B of the second insulator 22, and the second contact 23 is exposed through the opening portion 24A of the second waterproof sheet 24.

In an XY plane, the periphery of the second contact accommodating portion 22C is completely surrounded by the second joining surface 22B of planar shape, a second electric wire accommodating groove 22E, and a first electric wire accommodating groove 22F.

A +Z directional part of the insulating coating portion CB near the +Y directional end portion of the second electric wire C2 is accommodated in the second electric wire accommodating groove 22E of the second insulator 22 via the second waterproof sheet 24, and the conductor portion CA exposed from the insulating coating portion CB is connected to an electric wire connection portion 23A of the second contact 23 by, for example, soldering.

Note that a second protrusion portion 23E of the second contact 23 is situated on the −Z direction side of the second joining surface 22B of the second insulator 22 via the opening portion 24A of the second waterproof sheet 24, and a tip end-side contacting portion S1 faces in the −Z direction.

In addition, the second insulator 22 of the second connector 21 includes second locking portions 22G and second locked portions 22J to be described later that respectively have the same structures as those of the first locking portions 12G and the first locked portions 12J of the first insulator 12 of the first connector 11, and each second locking portion 22G has a through-hole penetrating the same in the X direction.

When the connector assembly according to Embodiment 1 is assembled, the second connector 21 is situated on the +Z direction side of the first connector 11 and pressed relatively against the first connector 11 in the −Z direction while oppositely facing in the X direction, the Y direction, and the Z direction from the first connector 11.

As a result, the second insulator 22 is superposed on the +Z direction side of the first insulator 12, and the first waterproof sheet 14 disposed on the first joining surface 12B and the second waterproof sheet 24 disposed on the second joining surface 22B are sandwiched between the first joining surface 12B and the second joining surface 22B and closely adhered to each other.

When the second insulator 22 is superposed on the +Z direction side of the first insulator 12, as shown in FIG. 3, the first locked portion 12J of the first insulator 12 is locked by the second locking portion 22G of the second insulator 22, while the second locked portion 22J of the second insulator 22 is locked by the first locking portion 12G of the first insulator 12, whereby the first insulator 12 and the second insulator 22 are fixed to each other.

Thus, the first connector 11 and the second connector 21 are fitted with each other, and the assembling operation of the connector assembly is completed.

At this time, as shown in FIG. 11, the tip end-side contacting portion S1 of the first contact 13 elastically contacts the base end-side contacting portion S2 of the second contact 23 in the Z direction, while the tip end-side contacting portion S1 of the second contact 23 elastically contacts the base end-side contacting portion S2 of the first contact 13 in the Z direction. Accordingly, the first contact 13 and the second contact 23 make contact with each other at two points separated from each other in the Y direction and are electrically connected to each other. Consequently, the first electric wire C1 and the second electric wire C2 are electrically connected to each other via the first contact 13 and the second contact 23 with high reliability.

In addition, a −Z directional part of the insulating coating portion CB near the −Y directional end portion of the first electric wire C1 is accommodated in the first electric wire accommodating groove 12E of the first insulator 12 via the first waterproof sheet 14, and a +Z directional part thereof is accommodated in the first electric wire accommodating groove 22F of the second insulator 22 via the second waterproof sheet 24.

Similarly, a +Z directional part of the insulating coating portion CB near the +Y directional end portion of the second electric wire C2 is accommodated in the second electric wire accommodating groove 22E of the second insulator 22 via the second waterproof sheet 24, and a −Z directional part thereof is accommodated in the second electric wire accommodating groove 12F of the first insulator 12 via the first waterproof sheet 14.

Further, as described above, when the first connector 11 and the second connector 21 are fitted with each other, the first waterproof sheet 14 disposed on the first joining surface 12B of planar shape so as to surround the first contact accommodating portion 12C and the second waterproof sheet 24 disposed on the second joining surface 22B of planar shape so as to surround the second contact accommodating portion 22C are pressed against each other in the Z direction and closely adhered to each other. Therefore, a waterproof structure can be easily formed by means of the first waterproof sheet 14 and the second waterproof sheet 24 each made of a rubber material or the like.

When the second locked portion 22J of the second insulator 22 is locked by the first locking portion 12G of the first insulator 12, as shown in FIG. 12, the second locked portion 22J is inserted into and caught by the through-hole 12H of the first locking portion 12G. Although not shown in the drawings, similarly, the first locked portion 12J is inserted into and caught by a through-hole of the second locking portion 22G. This constitution effectively prevents releasing of the fitted state due to movement of the second connector 21 in the fitted state in the +Z direction from the first connector 11.

In addition, when, of the first connector 11 and the second connector 21 in the fitted state, the first locking portion 12G and the second locking portion 22G are deformed by a tool such as a flat tip screwdriver to release the catching of the second locked portion 22J and the first locked portion 12J, the first connector 11 and the second connector 21 can be detached from each other.

### Embodiment 2

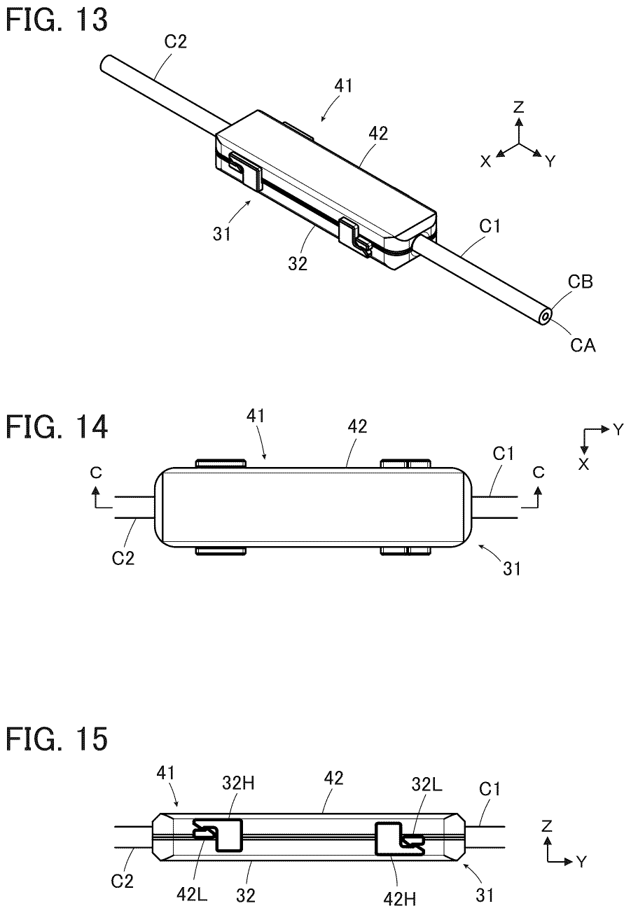

FIGS. 13 to 15 show a connector assembly according to Embodiment 2. The connector assembly includes a first connector 31 and a second connector 41, and when the second connector 41 is linearly slid relatively to the first connector 31, the first connector 31 and the second connector 41 are fitted with each other, and the first electric wire C1 and the second electric wire C2 are electrically connected to each other.

The first connector 31 is joined to a −Y directional end portion of the first electric wire C1, while the second connector 41 is joined to a +Y directional end portion of the second electric wire C2. The first electric wire C1 and the second electric wire C2 are the same as those used in Embodiment 1, are each formed of a coated electric wire in which an outer periphery of a conductor portion CA is covered with an insulating coating portion CB, and extend in opposite directions from each other on the same straight line.

The first connector 31 includes a first insulator 32 extending in the Y direction, while the second connector 41 includes a second insulator 42 extending in the Y direction. The first connector 31 and the second connector 41 are fitted with each other with the second insulator 42 being superposed on the first insulator 32.

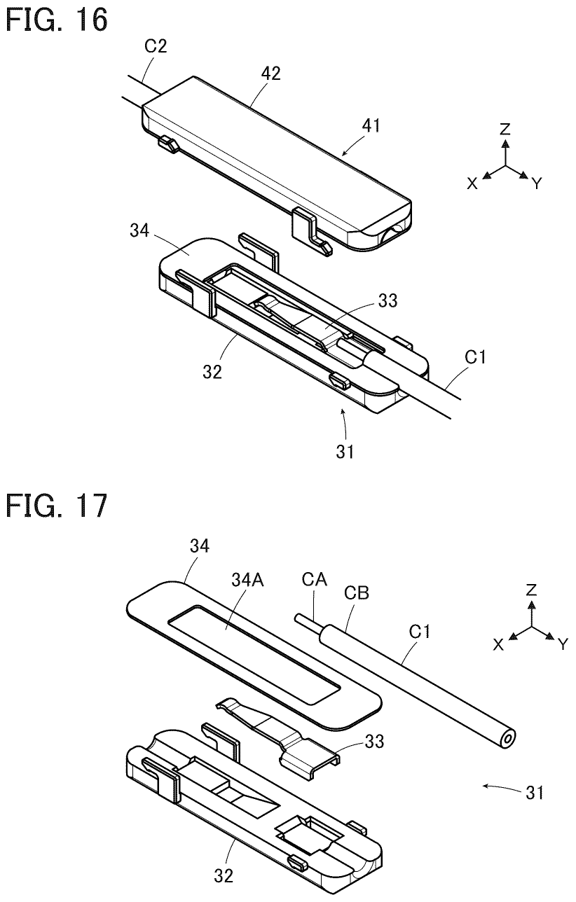

FIG. 16 shows the connector assembly of Embodiment 2 in a non-fitted state. The first connector 31 and the second connector 41 have the same configuration and are each hermaphroditically formed. The second connector 41 is fitted with the first connector 31 while oppositely facing in the X direction, the Y direction, and the Z direction from the first connector 31.

FIG. 17 shows an assembly view of the first connector 31. A first contact 33 is disposed on the +Z direction side of the first insulator 32, a first waterproof sheet 34 is disposed on the +Z direction side of the first contact 33, and the first electric wire C1 is disposed on the +Z direction side of the first waterproof sheet 34.

The first waterproof sheet 34 has a shape corresponding to an outer shape of the first insulator 32 when viewed from the +Z direction and is provided at the center thereof with a rectangular opening portion 34A extending in the Y direction. In addition, at the −Y directional end portion of the first electric wire C1, the insulating coating portion CB is removed to expose the conductor portion CA, and the exposed conductor portion CA of the first electric wire C1 is situated on the +Z direction side of the first contact 33 via the opening portion 34A of the first waterproof sheet 34.

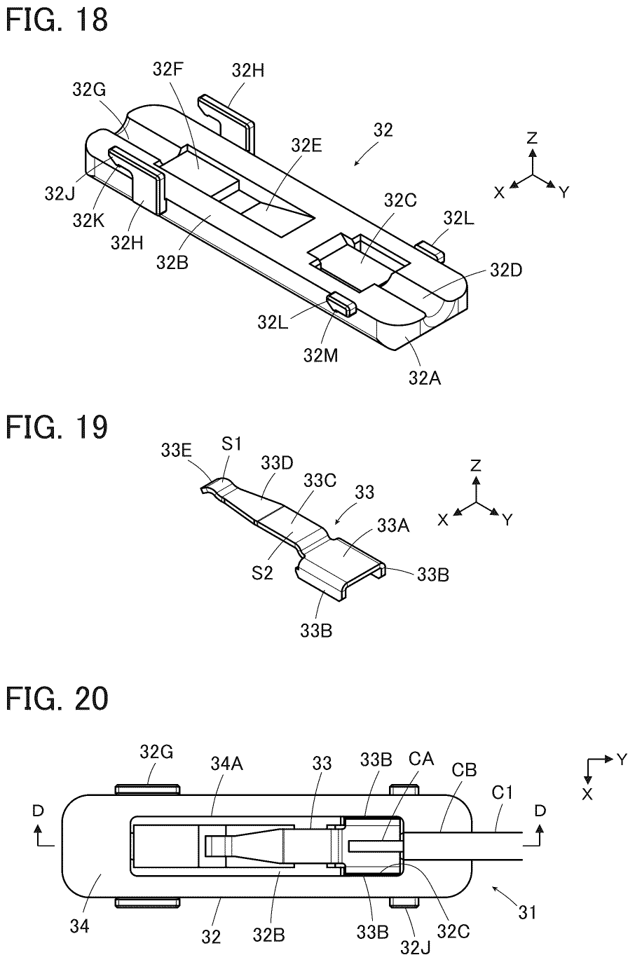

As shown in FIG. 18, the first insulator 32 is made of an insulating resin and includes a flat plate portion 32A of substantially rectangular shape extending in the Y direction along an XY plane. The flat plate portion 32A has a first joining surface 32B of planar shape facing in the +Z direction, and a recessed portion 32C opening in the +Z direction is formed in the first joining surface 32B at a position deviated to the +Y direction side from the Y directional center of the flat plate portion 32A.

In addition, the first joining surface 32B is provided with a first electric wire accommodating groove 32D extending in the Y direction from the recessed portion 32C to a +Y directional end portion of the first insulator 32.

Further, the first joining surface 32B is provided with a recessed portion 32E disposed at the Y directional center of the first insulator 32 and opening in the +Z direction, a communication groove 32F communicating with the recessed portion 32E and extending in the −Y direction from the recessed portion 32E, and a second electric wire accommodating groove 32G extending in the Y direction from the communication groove 32F to a −Y directional end portion of the first insulator 32.

The recessed portion 32C is configured to accommodate part of the first contact 33 to retain the first contact 33, and the recessed portion 32E is configured to accommodate a contacting portion between the first contact 33 and a second contact 43, to be described later, of the second connector 41 when the first connector 31 and the second connector 41 are fitted to each other. The recessed portions 32C and 32E form a first contact accommodating portion of recess shape disposed in the first joining surface 32B.

At opposite lateral portions of the flat plate portion 32A on the +X direction side and the −X direction side of the communication groove 32F, a pair of L-shaped first locking portions 32H are separately formed to overhang outward in the X direction from the flat plate portion 32A and protrude in the +Z direction. Each first locking portion 32H includes an arm portion 32J extending in the −Y direction on the +Z direction side from the first joining surface 32B, and a projection 32K protruding in the −Z direction from an intermediate portion of the arm portion 32J.

In addition, at opposite lateral portions of the flat plate portion 32A on the +X direction side and the −X direction side of the recessed portion 32C, a pair of first locked portions 32L are separately formed to overhang outward in the X direction from the flat plate portion 32A. The first locked portion 32L is provided with a projection 32M protruding in the −Z direction.

As shown in FIG. 19, the first contact 33 is formed of a metal sheet having conductivity and being bent and includes an electric wire connection portion 33A of substantially rectangular shape extending along an XY plane, and a pair of leg portions 33B being bent in the −Z direction separately from a +X directional end portion and a −X directional end portion of the electric wire connection portion 33A.

Further, the first contact 33 includes: an extending portion 33C once projecting in the +Z direction from a −Y directional end portion of the electric wire connection portion 33A and then extending in the −Y direction; and an arm portion 33D extending in the −Y direction further from the extending portion 33C, and at a −Y directional end portion of the arm portion 33D, a first protrusion portion 33E is formed to be curved so as to protrude in the +Z direction. A +Z directional surface of the first protrusion portion 33E forms a tip end-side contacting portion S1, while a +Z directional surface of the extending portion 33C forms a base end-side contacting portion S2.

As shown in FIG. 20, in the first connector 31, the pair of leg portions 33B of the first contact 33 are press-fitted into the recessed portion 32C, which forms part of the first contact accommodating portion, of the first insulator 32, whereby the first contact 33 is retained by the first insulator 32. In addition, the first waterproof sheet 34 made of a rubber material or the like is disposed on the first joining surface 32B of the first insulator 32, and the first contact 33 is exposed through the opening portion 34A of the first waterproof sheet 34.

Part of the conductor portion CA exposed from the insulating coating portion CB near the −Y directional end portion of the first electric wire C1 is connected to the electric wire connection portion 33A of the first contact 33 by, for example, soldering.

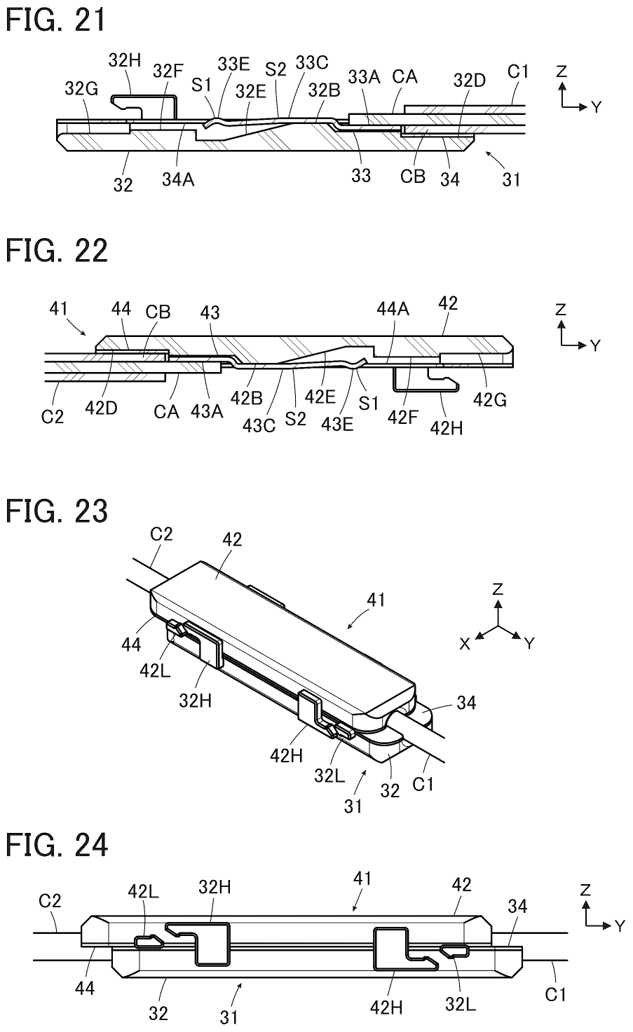

As shown in FIG. 21, a −Z directional part of the insulating coating portion CB near the −Y directional end portion of the first electric wire C1 is accommodated in the first electric wire accommodating groove 32D of the first insulator 32 via the first waterproof sheet 34.

Note that the first protrusion portion 33E of the first contact 33 is situated on the +Z direction side of the first joining surface 32B of the first insulator 32 via the opening portion 34A of the first waterproof sheet 34, and the tip end-side contacting portion S1 faces in the +Z direction side.

Here, FIG. 22 shows the second connector 41 to be fitted with the first connector 31. The second connector 41 has the same configuration as that of the first connector 31 and is fitted with the first connector 31 while oppositely facing in the X direction, the Y direction, and the Z direction from the first connector 31.

As shown in FIG. 22, in the second connector 41, a pair of leg portions of the second contact 43 are press-fitted into a recessed portion, which forms part of the second contact accommodating portion, of the second insulator 42, whereby the second contact 43 is retained by the second insulator 42. In addition, a second waterproof sheet 44 is disposed on a second joining surface 42B of the second insulator 42.

A +Z directional part of the insulating coating portion CB near the +Y directional end portion of the second electric wire C2 is accommodated in a second electric wire accommodating groove 42D of the second insulator 42 via the second waterproof sheet 44, and the conductor portion CA exposed from the insulating coating portion CB is connected to an electric wire connection portion 43A of the second contact 43 by, for example, soldering.

Note that a second protrusion portion 43E of the second contact 43 is situated on the −Z direction side of the second joining surface 42B of the second insulator 42 via an opening portion 44A of the second waterproof sheet 44, and the tip end-side contacting portion S1 faces in the −Z direction.

In addition, the second insulator 42 of the second connector 41 includes second locking portions 42H and second locked portions 42L to be described later that respectively have the same structures as those of the first locking portions 32H and the first locked portions 32L of the first insulator 32 of the first connector 31, each second locking portion 42H has a projection formed in its arm portion, and each second locked portion 42L has a projection.

When the connector assembly according to Embodiment 2 is assembled, first, as shown in FIG. 23, the second connector 41 is superposed on the first connector 31 on the +Z direction side thereof while oppositely facing in the X direction, the Y direction, and the Z direction from the first connector 31. At this time, in the state where the second waterproof sheet 44 of the second connector 41 makes contact with the first waterproof sheet 34 of the first connector 31, the second insulator 42 of the second connector 41 is disposed at a position apart from the first insulator 32 of the first connector 31 in the −Y direction by a predetermined distance.

Therefore, as shown in FIG. 24, the second locking portion 42H and the second locked portion 42L of the second connector 41 are respectively situated away from the first locked portion 32L and the first locking portion 32H of the first connector 31 in the −Y direction, and the first insulator 32 of the first connector 31 and the second insulator 42 of the second connector 41 are not locked by each other yet.

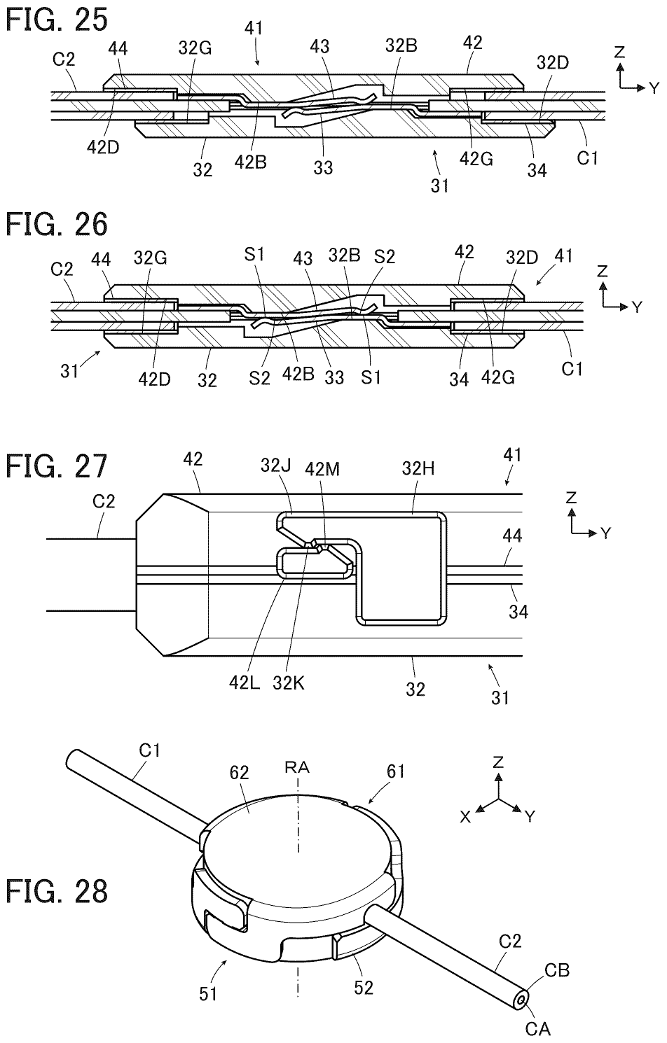

At this time, as shown in FIG. 25, the +Z directional part of the insulating coating portion CB near the −Y directional end portion of the first electric wire C1 is not yet sufficiently accommodated in the first electric wire accommodating groove 42G of the second insulator 42, while the −Z directional part of the insulating coating portion CB near the +Y directional end portion of the second electric wire C2 is not yet sufficiently accommodated in the second electric wire accommodating groove 32G of the second insulator 32.

In this state, when the second connector 41 is linearly slid in the +Y direction relatively to the first connector 31 until the second insulator 42 of the second connector 41 is situated at the same Y directional position as that of the first insulator 32 of the first connector 31, as shown in FIG. 26, the tip end-side contacting portion S1 of the first contact 33 elastically contacts the base end-side contacting portion S2 of the second contact 43 in the Z direction, while the tip end-side contacting portion S1 of the second contact 43 elastically contacts the base end-side contacting portion S2 of the first contact 33 in the Z direction. Accordingly, the first contact 33 and the second contact 43 make contact with each other at two points separated from each other in the Y direction and are electrically connected to each other. Consequently, the first electric wire C1 and the second electric wire C2 are electrically connected to each other via the first contact 33 and the second contact 43 with high reliability.

Thus, the first connector 31 and the second connector 41 are fitted with each other, and the assembling operation of the connector assembly is completed.

When the second connector 41 is linearly slid in the +Y direction relatively to the first connector 31 until the second insulator 42 of the second connector 41 is situated at the same Y directional position as that of the first insulator 32 of the first connector 31, as shown in FIG. 15, the first locked portion 32L of the first insulator 32 is locked by the second locking portion 42H of the second insulator 42, while the second locked portion 42L of the second insulator 42 is locked by the first locking portion 32H of the first insulator 32, whereby the first insulator 32 and the second insulator 42 are fixed to each other.

When the first insulator 32 and the second insulator 42 are fixed to each other in this manner, the first waterproof sheet 34 disposed on the first joining surface 32B of planar shape so as to surround the first contact accommodating portion and the second waterproof sheet 44 disposed on the second joining surface 42B of planar shape so as to surround the second contact accommodating portion are pressed against each other in the Z direction and closely adhered to each other.

In addition, as shown in FIG. 26, the −Z directional part of the insulating coating portion CB near the −Y directional end portion of the first electric wire C1 is accommodated in the first electric wire accommodating groove 32D of the first insulator 32 via the first waterproof sheet 34, and the +Z directional part thereof is accommodated in the first electric wire accommodating groove 42G of the second insulator 42 via the second waterproof sheet 44.

Similarly, a +Z directional part of the insulating coating portion CB near the +Y directional end portion of the second electric wire C2 is accommodated in the second electric wire accommodating groove 42D of the second insulator 42 via the second waterproof sheet 44, and a −Z directional part thereof is accommodated in the second electric wire accommodating groove 32G of the first insulator 32 via the first waterproof sheet 34.

Therefore, a waterproof structure can be easily formed by means of the first waterproof sheet 34 and the second waterproof sheet 44 each made of a rubber material or the like.

When the second locked portion 42L of the second insulator 42 is locked by the first locking portion 32H of the first insulator 32, as shown in FIG. 27, the projection 42M of the second locked portion 42L catches the projection 32K of the arm portion 32J of the first locking portion 32H. Although not shown in the drawings, similarly, the projection 32M of the first locked portion 32L catches the projection of the arm portion of the second locking portion 42H. This constitution effectively suppresses releasing of the fitted state due to linear advancement of the second connector 41 in the fitted state in the −Y direction from the first connector 31.

In addition, when the first connector 31 and the second connector 41 in the fitted state are linearly slid in an opposite direction from the fitting operation by a force by which the projection 32K of the first locking portion 32H and the projection of the second locking portion 42H pass over the projection 42M of the second locked portion 42L and the projection 32M of the first locked portion 32L, respectively, the first connector 31 and the second connector 41 can be detached from each other.

### Embodiment 3

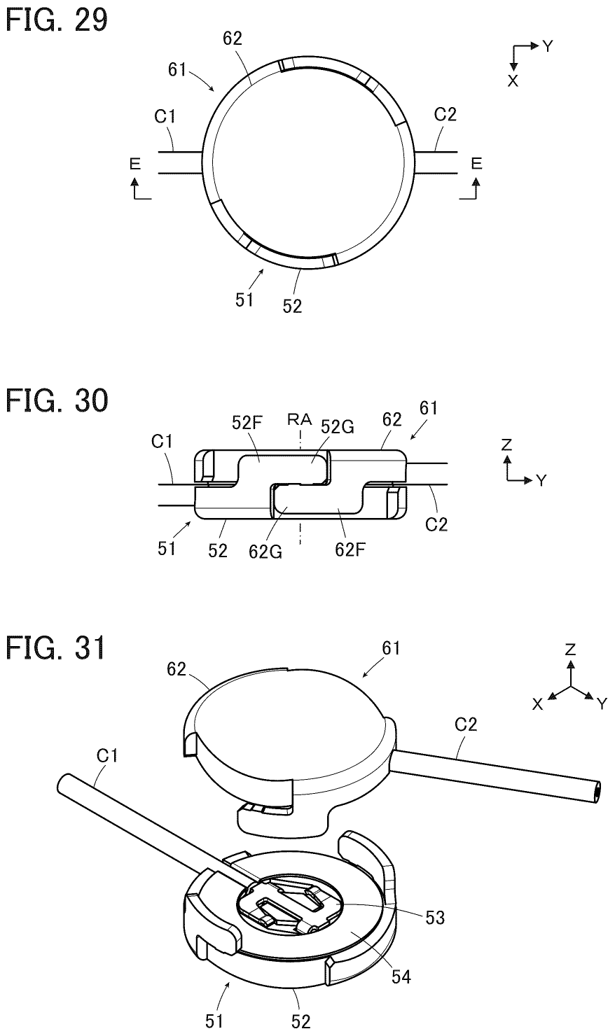

FIGS. 28 to 30 show a connector assembly according to Embodiment 3. The connector assembly includes a first connector 51 and a second connector 61, and when the second connector 61 is rotated and slid about a rotational axis RA relatively to the first connector 51, the first connector 51 and the second connector 61 are fitted with each other, and the first electric wire C1 and the second electric wire C2 are electrically connected to each other.

The first connector 51 is joined to a +Y directional end portion of the first electric wire C1, while the second connector 61 is joined to a −Y directional end portion of the second electric wire C2. The first electric wire C1 and the second electric wire C2 are the same as those used in Embodiments 1 and 2, are each formed of a coated electric wire in which an outer periphery of a conductor portion CA is covered with an insulating coating portion CB, and extend in opposite directions from each other on the same straight line.

The first connector 51 includes a first insulator 52 of substantially circular disk shape, and similarly, the second connector 61 includes a second insulator 62 of substantially circular disk shape. The first connector 51 and the second connector 61 are fitted with each other with the second insulator 62 being superposed on the first insulator 52.

The rotational axis RA passes the center of the first insulator 52 and the second insulator 62 each having a substantially circular disk shape and extends in the Z direction.

FIG. 31 shows the connector assembly of Embodiment 3 in a non-fitted state. The first connector 51 and the second connector 61 have the same configuration and are each hermaphroditically formed. The second connector 61 is rotated by a predetermined angle in an XY plane with respect to the first connector 51 at the start of fitting of the second connector 61 with the first connector 51, and at the time of completion of fitting, the second connector 61 is situated to oppositely face in the X direction, the Y direction, and the Z direction from the first connector 51.

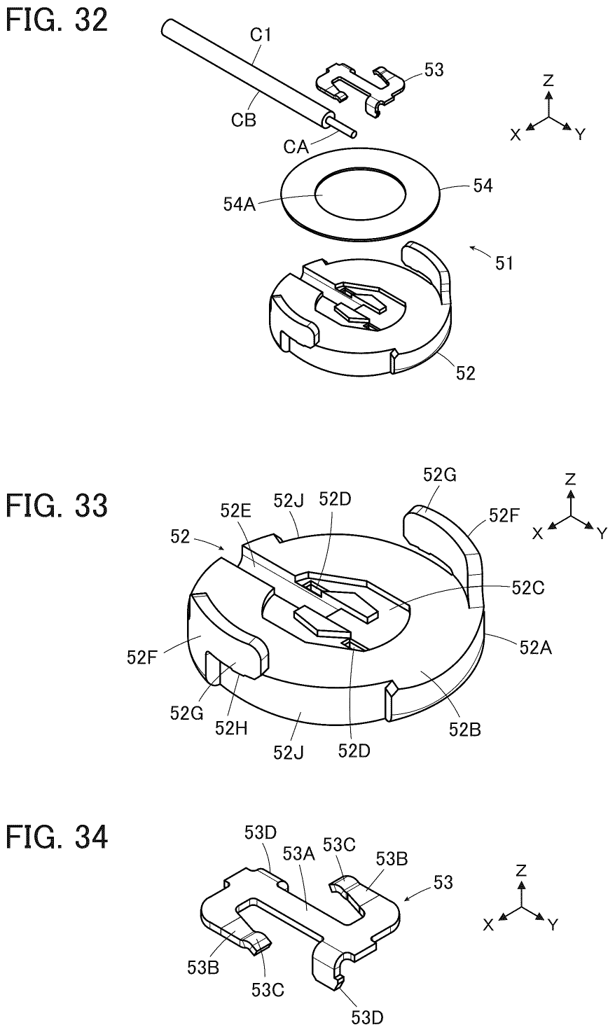

FIG. 32 shows an assembly view of the first connector 51. A first waterproof sheet 54 is disposed on the +Z direction side of the first insulator 52, the first electric wire C1 is disposed on the +Z direction side of the first waterproof sheet 54, and a first contact 53 is disposed on the +Z direction side of the first electric wire C1.

The first waterproof sheet 54 has a ring shape and is provided at the center thereof with a circular opening portion 54A when viewed from the +Z direction. In addition, at the +Y directional end portion of the first electric wire C1, the insulating coating portion CB is removed to expose the conductor portion CA, the exposed conductor portion CA of the first electric wire C1 is situated on the +Z direction side of the opening portion 54A of the first waterproof sheet 54, and the first contact 53 is situated on the +Z direction side of the exposed conductor portion CA of the first electric wire C1.

As shown in FIG. 33, the first insulator 52 is made of an insulating resin and includes a circular plate portion 52A of substantially circular shape extending along an XY plane. The circular plate portion 52A has a first joining surface 52B of planar shape facing in the +Z direction, and a first contact accommodating portion 52C of recess shape formed in the first joining surface 52B and opening in the +Z direction.

The first contact accommodating portion 52C is formed at the center of the circular plate portion 52A and is configured to accommodate and retain the first contact 53. The first contact accommodating portion 52C is provided with a pair of press-fitting holes 52D in which part of the first contact 53 is press-fitted.

In addition, the first joining surface 52B is provided with a first electric wire accommodating groove 52E extending in the Y direction from the first contact accommodating portion 52C to a −Y directional end portion of the circular plate portion 32A.

At lateral portions of the circular plate portion 52A, a pair of first locking portions 52F are separately formed to protrude in the +Z direction. The pair of first locking portions 52F are situated on one diameter of the circular plate portion 52A and face each other, and separately include arm portions 52G extending along the circumference of the circular plate portion 52A on the +Z direction side from the first joining surface 52B. The arm portions 52G of the pair of first locking portions 52F extend in the same rotational direction about the center of the circular plate portion 52A and are curved along the circumference of the circular plate portion 52A.

At an intermediate portion of the arm portion 52G in the circumferential direction of the circular plate portion 52A, a projection 52H is formed to protrude in the −Z direction.

Further, at lateral portions of the circular plate portion 52A, a pair of reduced diameter portions 52J are separately formed to be adjacent to the pair of first locking portions 52F and be recessed toward the center of the circular plate portion 52A. Each reduced diameter portion 52J extends from the −Z direction side of the arm portion 52G of the corresponding first locking portion 52F to the rotational position beyond the tip of the arm portion 52G along the circumferential direction of the circular plate portion 52A.

As shown in FIG. 34, the first contact 53 is formed of a metal sheet having conductivity and being bent and includes an electric wire connection portion 53A elongated in the Y direction along an XY plane, and a pair of extending portions 53B extending along an XY plane separately from a +Y directional end portion and a −Y directional end portion of the electric wire connection portion 53A.

The extending portion 53B joined to the +Y directional end portion of the electric wire connection portion 53A extends in the −X direction from the +Y directional end portion of the electric wire connection portion 53A along an XY plane and then extends in the −Y direction, and at a −Y directional end portion of the extending portion 53B, a first protrusion portion 53C is formed to be curved so as to protrude in the +Z direction.

On the other hand, the extending portion 53B joined to the −Y directional end portion of the electric wire connection portion 53A extends in the +X direction from the −Y directional end portion of the electric wire connection portion 53A along an XY plane and then extends in the +Y direction, and at a +Y directional end portion of the extending portion 53B, a first protrusion portion 53C is formed to be curved so as to protrude in the +Z direction.

Further, the first contact 53 has a pair of press-fitting portions 53D extending in the −Z direction separately from the +Y directional end portion and the −Y directional end portion of the electric wire connection portion 53A.

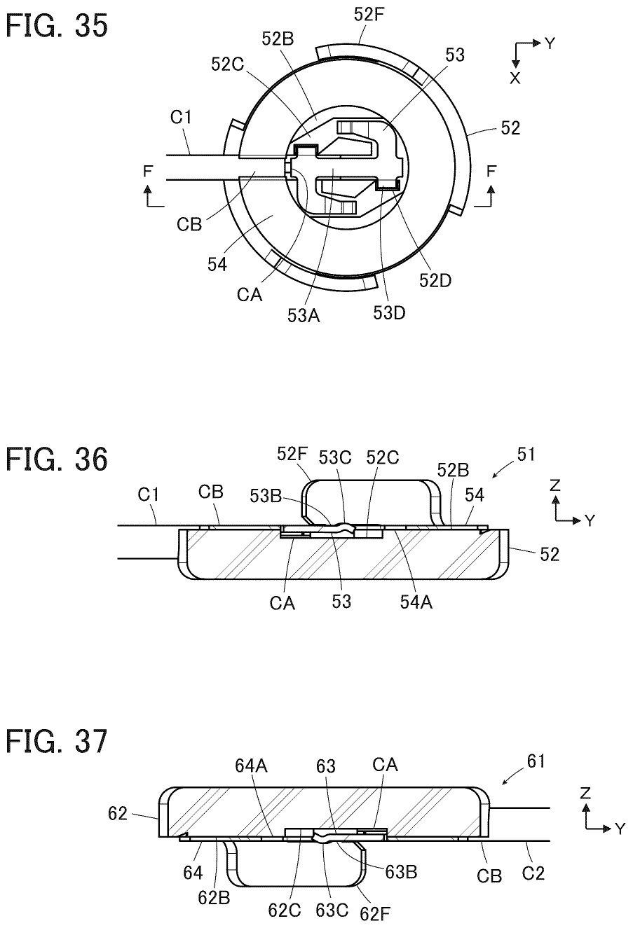

As shown in FIG. 35, in the first connector 51, the first waterproof sheet 54 made of a rubber material or the like is disposed on the first joining surface 52B of the first insulator 52.

Part of the conductor portion CA exposed from the insulating coating portion CB near the +Y directional end portion of the first electric wire C1 is connected to a −Z directional surface of the electric wire connection portion 53A of the first contact 53 by, for example, soldering, and the first contact 53 is accommodated in the first contact accommodating portion 52C of the first insulator 52. When the pair of press-fitting portions 53D are separately press-fitted into the pair of press-fitting holes 52D of the first contact accommodating portion 52C, the first contact 53 is fixed to the first insulator 52.

In addition, part of the insulating coating portion CB of the first electric wire C1 in which the part of the conductor portion CA is connected to the −Z directional surface of the electric wire connection portion 53A of the first contact 53 is accommodated in the first electric wire accommodating groove 52E of the first insulator 52 shown in FIG. 33 via the first waterproof sheet 54.

As shown in FIG. 36, the pair of first protrusion portions 53C separately formed in the pair of extending portions 53B of the first contact 53 are disposed on the +Z direction side of the first contact accommodating portion 52C of the first insulator 52 via the opening portion 54A of the first waterproof sheet 54 and situated on the +Z direction side from the first joining surface 52B.

Here, FIG. 37 shows the second connector 61 to be fitted with the first connector 51. The second connector 61 has the same configuration as that of the first connector 51 and is fitted with the first connector 51 while oppositely facing in the X direction, the Y direction, and the Z direction from the first connector 51.

In the second connector 61, a second contact 63 is accommodated in a second contact accommodating portion 62C of the second insulator 62, and a second waterproof sheet 64 is disposed on a second joining surface 62B of the second insulator 62.

Part of the conductor portion CA exposed from the insulating coating portion CB near the −Y directional end portion of the second electric wire C2 is connected to the second contact 63 by, for example, soldering, and the second contact 63 is accommodated in the second contact accommodating portion 62C of the second insulator 62.

A pair of second protrusion portions 63C separately formed at a pair of extending portions 63B of the second contact 63 are disposed on the −Z direction side of the second contact accommodating portion 62C of the second insulator 62 via an opening portion 64A of the second waterproof sheet 64 and situated on the −Z direction side from the second joining surface 62B.

In addition, the second insulator 62 of the second connector 61 includes a pair of second locking portions 62F having the same structure as that of the first locking portions 52F of the first insulator 52 of the first connector 51, and each second locking portion 62F includes a projection 62H formed at an arm portion 62G to be described later.

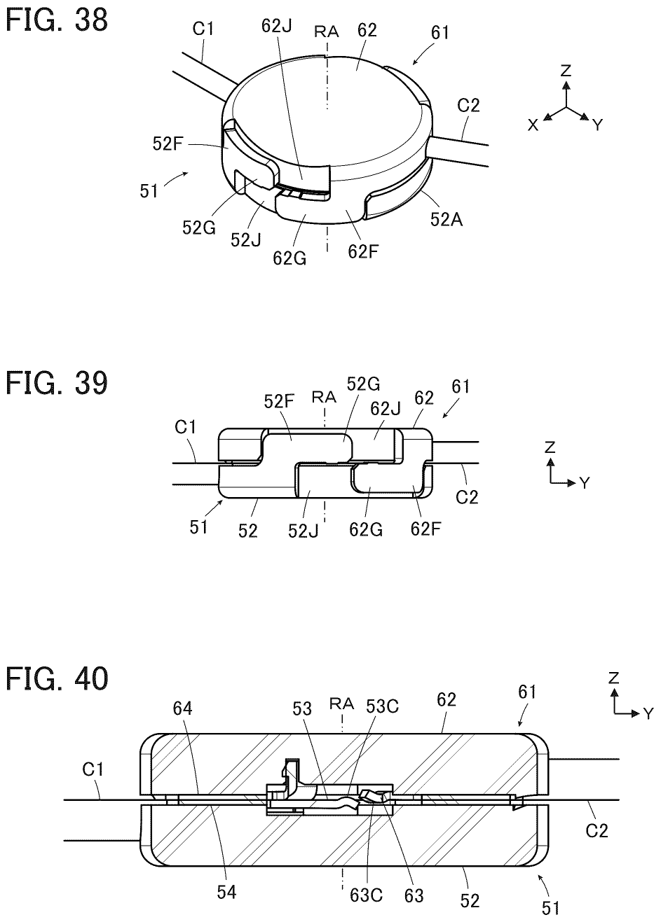

When the connector assembly according to Embodiment 3 is assembled, first, as shown in FIG. 38, the second connector 61 is superposed on the first connector 51 on the +Z direction side thereof so as to oppositely face in the Z direction from the first connector 51. With the second connector 61 being situated at such a rotational position that the second electric wire C2 joined to the second connector 61 extends in a direction rotated from the Y direction about the rotational axis RA by a predetermined angle, the arm portion 62G of the second locking portion 62F of the second insulator 62 is situated along an outer peripheral portion of the reduced diameter portion 52J of the first insulator 52, and the arm portion 52G of the first locking portion 52F of the first insulator 52 is situated along the outer peripheral portion of the reduced diameter portion 62J of the second insulator 62; in this state, the second connector 61 can be superposed on the first connector 51 on the +Z direction side thereof.

At this time, as shown in FIG. 39, the arm portion 52G of the first locking portion 52F and the arm portion 62G of the second locking portion 62F are situated at rotational positions different from each other in the rotational direction about the rotational axis RA, and the first insulator 52 of the first connector 51 and the second insulator 62 of the second connector 61 are not locked by each other yet.

In addition, at this time, as shown in FIG. 40, the second contact 63 of the second connector 61 is situated away from the first contact 53 in the rotational direction about the rotational axis RA and does not make contact with the first contact 53 of the first connector 51 yet.

Further, when the second connector 61 is superposed on the first connector 51 on the +Z direction side thereof, the second waterproof sheet 64 of the second connector 61 makes contact with the first waterproof sheet 54 of the first connector 51.

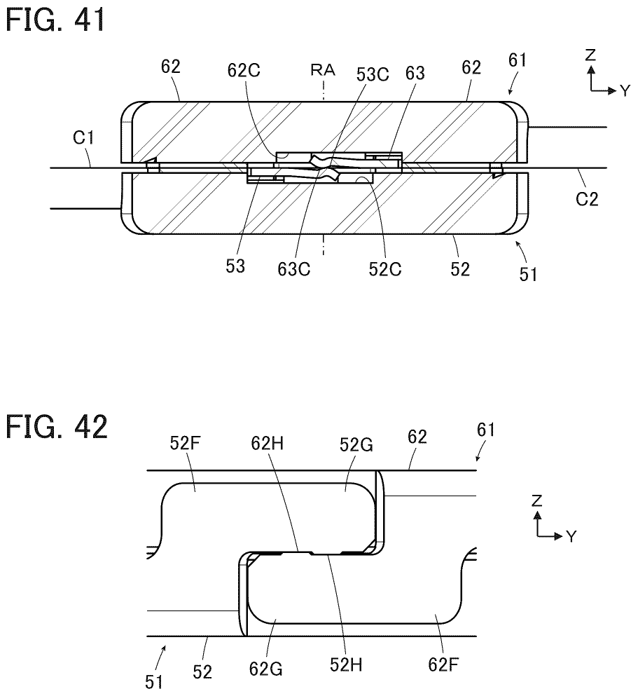

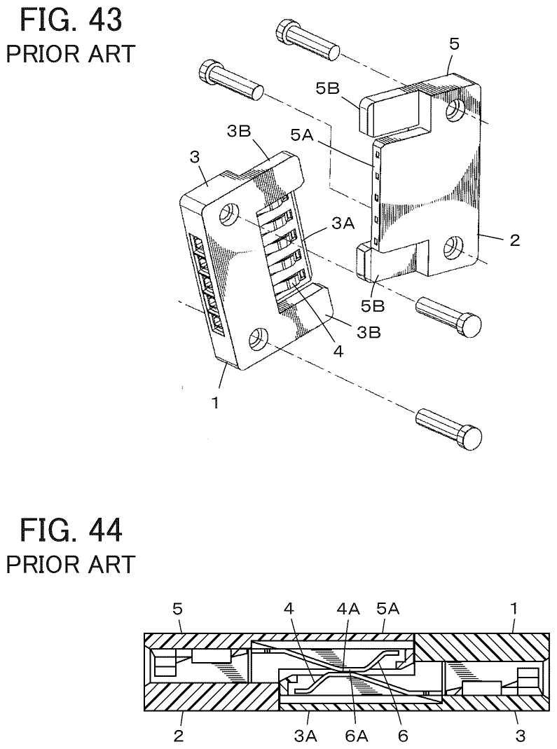

In this state, when the second connector 61 is rotated and slid about the rotational axis RA relatively to the first connector 51 until a direction in which the second electric wire C2 joined to the second connector 61 extends coincides with the Y direction, as shown in FIG. 41, the first connector 51 and the second connector 61 are moved relative to each other until the first protrusion portion 53C of the first contact 53 and the second protrusion portion 63C of the second contact 63 pass over each other, and the pair of first protrusion portions 53C of the first contact 53 elastically contact the pair of second protrusion portions 63C of the second contact 63. Accordingly, the first contact 53 and the second contact 63 make contact with each other at two points separated from each other and are electrically connected to each other. Consequently, the first electric wire C1 and the second electric wire C2 are electrically connected to each other via the first contact 53 and the second contact 63 with high reliability.

Thus, the first connector 51 and the second connector 61 are fitted with each other, and the assembling operation of the connector assembly is completed.

When the second connector 61 is rotated and slid about the rotational axis RA relatively to the first connector 51 until the direction in which the second electric wire C2 joined to the second connector 61 extends coincides with the Y direction, as shown in FIG. 30, the arm portion 52G of the first locking portion 52F of the first insulator 52 and the arm portion 62G of the second locking portion 62F of the second insulator 62 are situated to be superposed on each other in the Z direction. Thus, the first locking portion 52F and the second locking portion 62F interfere with each other, and the first insulator 52 and the second insulator 62 are locked by and fixed with each other.

When the first insulator 52 and the second insulator 62 are fixed to each other in this manner, the first waterproof sheet 54 disposed on the first joining surface 52B of planar shape so as to surround the first contact accommodating portion 52C and the second waterproof sheet 64 disposed on the second joining surface 62B of planar shape so as to surround the second contact accommodating portion 62C are pressed against each other in the Z direction and closely adhered to each other.

Further, part of the insulating coating portion CB near the +Y directional end portion of the first electric wire C1 is accommodated in the first electric wire accommodating groove 52E of the first insulator 52 via the first waterproof sheet 54. In addition, as with the first insulator 52, the second insulator 62 includes a second electric wire accommodating groove formed in the second joining surface 62B and extending in the Y direction from the second contact accommodating portion 62C to a +Y directional end portion of the second insulator 62, and part of the insulating coating portion CB near a −Y directional end portion of the second electric wire C2 are accommodated in the second electric wire accommodating groove of the second insulator 62 via the second waterproof sheet 64.

Therefore, a waterproof structure can be easily formed by means of the first waterproof sheet 54 and the second waterproof sheet 64 each made of a rubber material or the like.

When the first insulator 52 and the second insulator 62 are locked by each other, as shown in FIG. 42, the projection 52H of the arm portion 52G of the first locking portion 52F catches the projection 62H of the arm portion 62G of the second locking portion 62F. This constitution effectively suppresses releasing of the fitted state due to rotation of the second connector 61 in the fitted state about the rotational axis RA with respect to the first connector 51.

Since the first protrusion portion 53C of the first contact 53 and the second protrusion portion 63C of the second contact 63 pass over each other when the first connector 51 and the second connector 61 are fitted with each other, the constitution where the first protrusion portion 53C and the second protrusion portion 63C interfere with each other also suppresses releasing of the fitted state due to shifting of the second connector 61 in the −Y direction from the first connector 51.

In Embodiment 3 above, the first contact 53 includes the pair of first protrusion portions 53C, while the second contact 63 includes the pair of second protrusion portions 63C, but the invention is not limited thereto, and the connector assembly may be configured such that only one first protrusion portion 53C included in the first contact 53 and only one second protrusion portion 63C included in the second contact 63 make elastic contact with each other in the Z direction.

Meanwhile, as described in Embodiment 3 above, when the first contact 53 and the second contact 63 make contact with each other at two points by means of the pair of first protrusion portions 53C and the pair of second protrusion portions 63C, the reliability of the electric connection can be improved.

In addition, when the first connector 51 and the second connector 61 in the fitted state are rotated and slid in an opposite direction from the fitting operation by a force by which the projection 52H of the first locking portion 52F passes over the projection 62H of the second locking portion 62F, the first connector 51 and the second connector 61 can be detached from each other.

In the connector assembly of each of Embodiments 1 to 3 above, since the first electric wire C1 and the second electric wire C2 are electrically connected with each other by means of the first connector 11, 31, 51 and the second connector 21, 41, 61, by only fitting and detaching the first connector 11, 31, 51 and the second connector 21, 41, 61 with and from each other, connection and blocking between the first electric wire C1 and the second electric wire C2 can be easily switched.

Further, since the first connector 11, 31, 51 and the second connector 21, 41, 61 have the same configuration and are each hermaphroditically formed, the production cost of the connector assembly can be reduced, and erroneous connection of the end portion of the first electric wire C1 and the end portion of the second electric wire C2 with the connectors can be prevented, so electrical connection between the first electric wire C1 and the second electric wire C2 can be reliably established.

What is claimed is:

1. A connector assembly in which a first connector and a second connector are fitted with each other, the first connector being joined to an end portion of a first electric wire, and the second connector being joined to an end portion of a second electric wire and having a same configuration as that of the first connector,
wherein the first connector includes: a first insulator; a first contact retained by the first insulator and connected to the end portion of the first electric wire; and a first waterproof sheet,
the second connector includes: a second insulator; a second contact retained by the second insulator and connected to the end portion of the second electric wire; and a second waterproof sheet,
the first insulator includes: a first joining surface of planar shape; and a first contact accommodating portion of recess shape which is formed in the first joining surface and in which the first contact is accommodated,
the second insulator includes: a second joining surface of planar shape facing the first joining surface; and a second contact accommodating portion of recess shape which is formed in the second joining surface and in which the second contact is accommodated, and
the first waterproof sheet is disposed on the first joining surface so as to surround the first contact accommodating portion,
the second waterproof sheet is disposed on the second joining surface so as to surround the second contact accommodating portion, and
when the first connector and the second connector are fitted with each other, the first waterproof sheet and the second waterproof sheet are sandwiched between the first joining surface and the second joining surface and closely adhered to each other, and the first contact and the second contact make contact with each other, whereby the first electric wire and the second electric wire are electrically connected to each other.

2. The connector assembly according to claim 1,
wherein each of the first electric wire and the second electric wire is constituted of a coated electric wire in which an outer peripheral portion of a conductor portion is covered with an insulating coating portion,
the conductor portion at the end portion of the first electric wire is connected to the first contact in the first contact accommodating portion, and
the conductor portion at the end portion of the second electric wire is connected to the second contact in the first contact accommodating portion.

3. The connector assembly according to claim 2,
wherein the first insulator has a first electric wire accommodating groove which is formed in the first joining surface so as to communicate with the first contact accommodating portion and in which the insulating coating portion of the first electric wire is accommodated,
the second insulator has a second electric wire accommodating groove which is formed in the second joining surface so as to communicate with the second contact accommodating portion and in which the insulating coating portion of the second electric wire is accommodated,
the first waterproof sheet is sandwiched between a bottom surface of the first electric wire accommodating groove and the insulating coating portion of the first electric wire, and
the second waterproof sheet is sandwiched between a bottom surface of the second electric wire accommodating groove and the insulating coating portion of the second electric wire.

4. The connector assembly according to claim 3, wherein the second connector is pressed relatively against the first connector along a direction orthogonal to the first joining surface and the second joining surface, whereby the first connector and the second connector are fitted with each other.

5. The connector assembly according to claim 3, wherein the first connector and the second connector are moved relative to each other along the second joining surface and the first joining surface to thereby be fitted with each other.

6. The connector assembly according to claim 5,
wherein the first contact includes a first protrusion portion protruding toward the second connector,
the second contact includes a second protrusion portion protruding toward the first connector, and
the first connector and the second connector are moved relative to each other until the first protrusion portion and the second protrusion portion pass over each other.

7. The connector assembly according to claim 5, wherein the first connector and the second connector are moved relative to each other so as to be linearly slid with respect to each other.

8. The connector assembly according to claim 5, wherein the first connector and the second connector are moved relative to each other so as to be rotated and slid with respect to each other.

9. The connector assembly according to claim 1,
wherein the first insulator includes a first locking portion and a first locked portion,
the second insulator includes a second locking portion and a second locked portion, and
when the first connector and the second connector are fitted with each other, the first locked portion is locked by the second locking portion, and the second locked portion is locked by the first locking portion, whereby the first insulator and the second insulator are fixed to each other.

10. The connector assembly according to claim 1,
wherein the first insulator includes a first locking portion,
the second insulator includes a second locking portion, and
when the first connector and the second connector are fitted with each other, the first locking portion and the second locking portion interfere with each other, whereby the first insulator and the second insulator are fixed to each other.

11. The connector assembly according to claim 1, wherein the first contact and the second contact make contact with each other at two points.
